(19) United States
(12) Patent Application Publication
(10) Pub. No.: US 2025/0233805 A1
(43) Pub. Date: Jul. 17, 2025

(54) LIFE CYCLE MANAGEMENT FOR AI/ML AIR INTERFACE

(71) Applicants: Ziyi Li, Beijing (CN); Yi Guo, Shanghai (CN); Sudeep K. Palat, Cheltenham (GB); Meghashree Dattatri Kedalagudde, Hillsboro, OR (US); Debdeep Chatterjee, San Jose, CA (US)

(72) Inventors: Ziyi Li, Beijing (CN); Yi Guo, Shanghai (CN); Sudeep K. Palat, Cheltenham (GB); Meghashree Dattatri Kedalagudde, Hillsboro, OR (US); Debdeep Chatterjee, San Jose, CA (US)

(21) Appl. No.: 19/098,054

(22) Filed: Apr. 2, 2025

Related U.S. Application Data
(60) Provisional application No. 63/574,732, filed on Apr. 4, 2024.

(51) Int. Cl. H04L 41/16; H04W 8/22; H04W 76/27

(52) U.S. Cl. CPC H04L 41/16; H04W 8/22; H04W 76/27

(57) ABSTRACT

Systems and methods are disclosed for functionality-based life cycle management (LCM) of artificial intelligence/machine learning (AI/ML) models in wireless communications. A user equipment (UE) transmits capability information indicating support for AI/ML sub-use cases and receives radio resource control (RRC) configuration comprising applicable conditions for model identification. These conditions include network-side configurations and associated identifiers that abstract additional proprietary deployment characteristics without explicit disclosure. The UE determines model availability for inferencing based on received conditions and reports this to the network. Model identification occurs through alignment of applicable conditions, associated identifiers, or datasets between network and UE. The approach enables management of AI/ML models at a functionality level rather than specific model level, supporting operations including model selection, activation/deactivation, switching, and performance monitoring while maintaining consistency between training and inference conditions.

### PRIORITY CLAIM

This application claims the benefit of priority under 37 CFR 119(e) to U.S. Provisional Patent Application Ser. No. 63/574,732, filed Apr. 4, 2024, which is incorporated herein by reference in its entirety.

### TECHNICAL FIELD

Embodiments pertain to wireless networks and wireless communications. Some embodiments relate to life cycle management of artificial intelligence/machine learning (AI/ML) air interface.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various user equipment (UEs) and applications. NR is to be a unified network/system that is to meet vastly different and sometimes conflicting performance dimensions and services driven by different services and applications. As such, the complexity of such communication systems, as well as interactions between elements within a communication system, has increased. In particular, with the permeation of AI/ML into all aspects of technology, it is desirable to apply AI/ML techniques to Life Cycle Management (LCM) of the NR air interface to effectively synchronize between the network and UE regarding model identification of specific models, particularly for UE-side models or UE parts of two-sided models.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates model registration in accordance with some aspects.

FIG. 4 illustrates a Medium Access Control Control Element (MAC CE) in accordance with some aspects.

FIG. 5 illustrates another model registration in accordance with some aspects.

FIG. 6 illustrates an activation/deactivation MAC CE in accordance with some aspects.

FIG. 7 illustrates functionally based LCM in accordance with some aspects.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

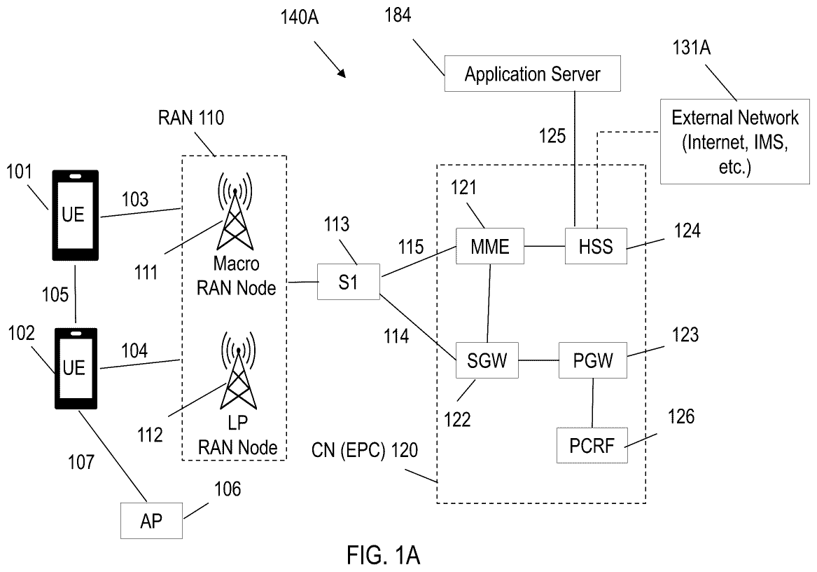

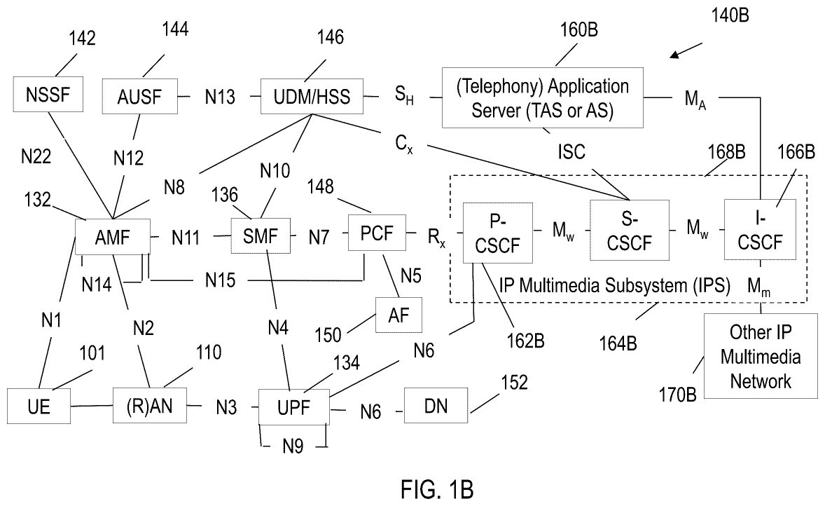

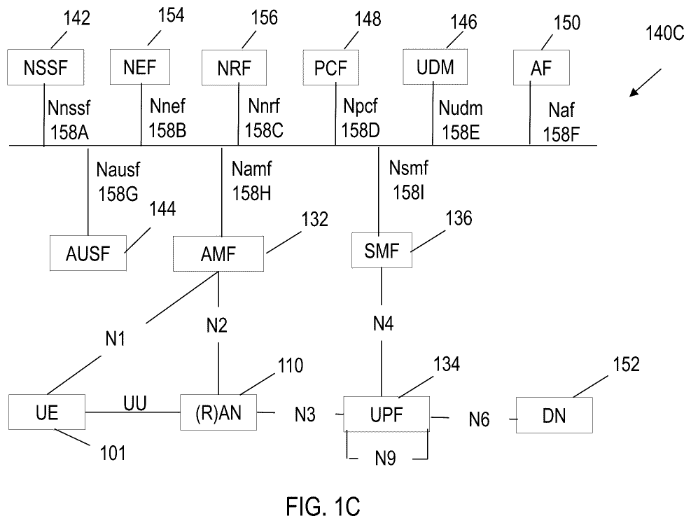

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the SI interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks.

Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

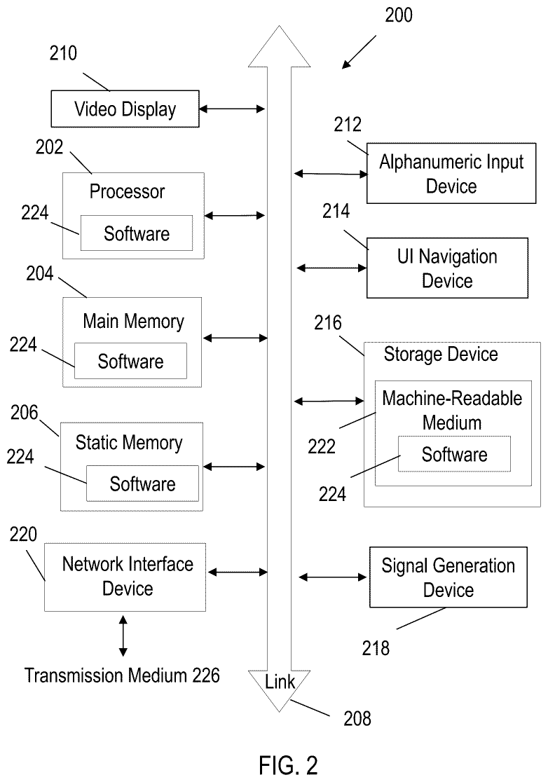

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile

Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHZ, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHZ, 902-928 MHz (note: allocated for example in US (FCC Part 15)), 863-868.6 MHZ (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHZ, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, the application of AI/ML techniques to NR air interface is being studied in Rel-19. As one part of this, model identification procedures for UE-side or UE-part of two-sided AI/ML models in the NR air interface are described herein. The technique herein addresses how to synchronize between the network and the UE regarding model identification of specific AI/ML models. Specifically, model identification for UE-sided model or a NW-trained UE-sided model is disclosed in which the model identification of a specific AI/ML model is synchronized between the NW and UE. Also disclosed are management control and UE capability reporting between the network and the UE, radio resource control (RRC) state change, the area scope of the AI/ML model and group UEs sharing the AI/ML model. In particular, the model ID is globally unique and pre-assigned to the entity that is responsible for model training and/or model storage.

### NW-Request/UE Initiated Model Identification

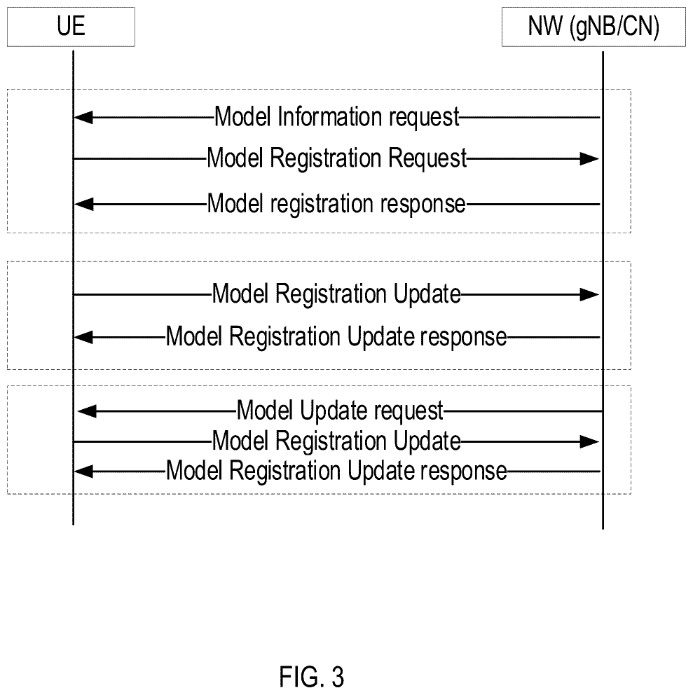

In this embodiment, the AI/ML model (the UE-sided model or the UE part of the two-sided model) is trained by the UE or the UE-side Over-The-Top (OTT) server, the UE performs a model identification procedure to synchronize the model ID of the active model to the NW for information. The OTT server is a server that operates on the UE side and can be involved in model training and management. The model ID can further be used for model management. FIG. 3 illustrates model registration in accordance with some aspects.

A model initial registration can be completed between the UE and the NW (e.g., the gNB and/or core network (CN)) via MAC CE, RRC, and/or non-access stratum (NAS) signaling. As shown in FIG. 3, the model initial registration procedure includes model information communication, model registration communication (request/response and update request/response), and model update communication.

Model Information Request: the UE reports its AI/ML capability (including but not limited to supported sub-use cases, etc.) to the NW, the NW sends a message via RRC and/or NAS signaling to request the UE to report the available AI/ML model information. The request information includes the use cases of the AI/ML model, model format (open format or proprietary format, if open format, also includes detailed open format request), and applicable conditions of the AI/ML model. The applicable conditions of the AI/ML model can also be looked-up in a database that is pre-assigned/designed to maintain the mapping between model ID and other model information, including applicable conditions and dataset ID.

Model Registration Request: the UE sends its global unique model ID(s) to the NW via MAC CE, RRC, and/or non-access stratum (NAS) signaling together with the requested information in the Model Information Request message. The UE can autonomously send the model registration request to the CN via NAS signaling.

The UE further includes a management request indicator to indicate whether the NW is to perform model management. The UE further includes the uncertainty level of model. If NW-collected data is to be used by the UE or if a NW-maintained dataset is to be used by the UE, the UE further includes data collection/data set request. The request includes requested data to be collected by the NW, and/or dataset ID/tag that mapped to the model ID, etc. Alternatively, the data collection message can include the corresponding model ID if a separate procedure for data collection is used. Alternatively, dataset and data collection for the requested model can be decided by the NW, e.g., based on mapping between the model ID and dataset. If the UE has collected data on its own (i.e., without data from the NW), the UE further reports the input data for model training/inference to the NW for grant.

Model Registration Response: the NW sends a response to the model identification (success/failure) to the UE, including global model ID and confirmed applicable conditions that the AI/ML model can be used.

This message further includes an indicator to indicate whether management can be performed at the NW side.

If model management is performed at the UE side, the message includes a performance indicator and a corresponding configuration (e.g., key performance indicator (KPI), monitoring periodicity, monitoring granularity, monitoring duration, reporting event, filtering metrics, etc.) to monitor and to report the performance information. The UE performs model performance monitoring following this configuration. The performance indicator can be per model, per model output, and/or per performance KPI.

The message further includes the expected performance (e.g., threshold) and uncertainty level of AI/ML model outputs. This information can either configured per model, per model output, or per performance indicator.

If NW-collected data is used by the UE or if an NW maintained dataset is used by the UE, this message further includes an indication whether a dataset tag/data can be provided by the NW, the dataset ID/tag, data/dataset transfer configuration, etc. The NW either transfers data/dataset together with this message or transfers the dataset over the user plane (UP). In some embodiments, the gNB can request the dataset from Operations, Administration and Maintenance (OAM) or the CN, then transfer to the UE. Alternatively, the gNB can decide what data collection is to be provided to the NW based on model information. The configuration for the UE to receive the dataset and data is sent to the UE via a Model Registration response message or via data collection configuration.

If UE collected data on its own, this message further includes the allowed data collection by the NW configuration for data collection.

Alternatively, the NW sends a trained model to the UE if model identification fails. The NW-trained model can be selected by the NW by implementation based on applicable conditions reported in the Model Registration Request message and UE capability, etc. An indicator is used to indicate whether a NW-trained model will be sent to UE if a separate model is not transferred in the Model Registration Response message.

Alternatively, the NW can send an indication to the UE to indicate that a NW-sided model will be used for this functionality/applicable condition.

If model management is located at the UE-side, since the UE trains the model on its own or via the UE OTT-server, the UE sends a model information update message via MAC CE, RRC, and/or NAS signaling to the gNB/CN (e.g., the Model Registration update message): 1) the message includes the model ID, the updated model information after a model update, including applicable conditions, model format information, etc. and 2) the message includes model status, indicating whether the registered model is still active.

The network further confirms the update via MAC CE, RRC, and/or NAS signaling, e.g., the model registration update response message (including the model ID).

If model management is located at the NW side, the NW (e.g., the gNB, CN) can request the model to be updated by the UE over air interface signaling (e.g., RRC or NAS): 1) the NW can request UE to update UE-side model based on, e.g., model performance monitoring, periodicity, etc. via RRC and/or NAS signaling (e.g., a model update request). The NW can further provide expected model performance KPIs, uncertainty level of AI/ML model output(s) and others; 2) the UE performs a model update to meet the NW configuration/requirement. The UE further provides a model information update to the NW via MAC CE, RRC, and/or NAS signaling (e.g., the model registration update request), and 3) the NW confirms the update via MAC CE, RRC, and/or NAS signaling (e.g., the model registration update response).

In some embodiments, the termination of model identification can be the CN.

In some embodiments, the network looks up the data collection for a specific model in a pre-assigned/designed database, based on a mapping between the model ID and dataset ID/tag.

In some embodiments, the model initial registration (e.g., the model information request, model registration request) can reuse the UE capability reporting framework, where the model ID is considered as part of the UE capability. UE assistance information (UAI) is used to update the active model ID to the network.

In some embodiment, the NW can further assign a local ID to the UE for the physical model via RRC signaling or MAC CE.

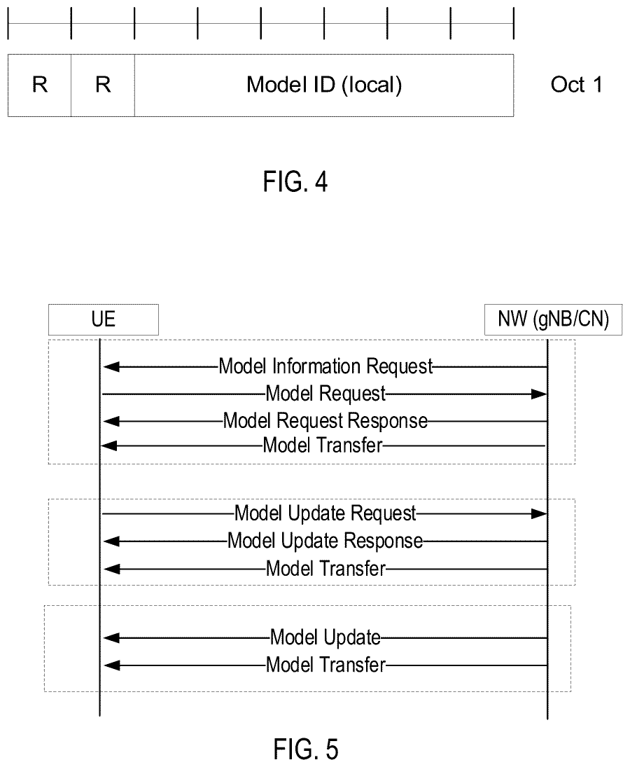

An example of a MAC CE is shown in FIG. 4, which illustrates a MAC CE in accordance with some aspects. FIG. 4 shows a 1 octet MAC CE in which 6 bits are used for the Model ID and 2 bits are reserved.

### NW-Initiated Model Identification

In this embodiment, the AI/ML model (the UE-sided model or the UE part of the two-sided model) is trained by the NW (e.g., the gNB, CN, and/or OAM), the UE performs a model identification procedure to request an AI/ML model and its corresponding ID from the NW. The model ID can further be used for model management.

FIG. 5 illustrates another model registration in accordance with some aspects. As shown in FIG. 5, the model initial registration procedure includes model information communication, model registration communication, model transfer, and model update communication.

The model initial registration can be completed between the UE and the NW (e.g., the gNB and/or CN) via MAC CE, RRC, and/or NAS signaling. An example:

Model Request: the UE requests the NW to send its trained model to the UE via RRC and/or NAC signaling. The UE can send the request based on a network request. Alternatively, the UE can also be triggered based on network-configured triggers or UE autonomous triggers (e.g., an applicable condition changes and a new model is used, etc.). The message includes the use case of the AI/ML model, model format (open format or proprietary format, if open format, also includes a detailed open format request), applicable conditions of the model, the UE AI/ML model processing (software/hardware) conditions, etc. In some embodiments, the above information except model ID can be replaced by model interoperability information that is maintained by different vendors offline. In some embodiments, the AI/ML processing conditions can be replaced by the UE capability reporting.

Alternatively, the model request message can be replaced by the UE capability information message.

Alternatively, the model request message can be replaced by applicable condition reporting via an RRC message, e.g., UAI/needForGap.

The network can trigger an information collection request for the UE-supported models in the UE information request (for the gNB terminated case) or a new message. The UE can also encode model request information in the UEInformationResponse message.

Model Request Response: the NW sends a global unique model ID(s) to the UE via MAC CE, RRC, and/or NAS signaling, together with model information, including but not limited to, model format and model applicable conditions.

If the NW collected data is to be used by the UE or if the NW maintained dataset is to be used by the UE, the message further includes the requested data and/or dataset ID/tag that maps to the model ID, among others.

If the UE collected data on its own, the NW further includes the input data for model training/inference and configuration for data collection (e.g., collection duration, periodicity, reporting configuration, etc.). Alternatively, the data collection message (e.g., measConfig) can include the corresponding model ID if a separate procedure for data collection is used.

The message further includes a management indicator to indicate whether the NW allows the UE to perform model management.

If model management is performed at the UE side, the message includes a performance indicator and corresponding configuration (e.g., KPI, monitoring periodicity, monitoring granularity, monitoring duration, reporting event, filtering metrics) to monitor and to report. The UE performs model performance monitoring following this configuration. The performance indicator can be per model, per model output, and/or per performance KPI.

Model Transfer: the NW sends the AI/ML model together with the model ID via a model request response message via RRC and/or NAS signaling over the control plane (CP), or via a separate RRC signaling and/or NAS via a separate signaling radio bearer (SRB). Alternatively, the NW sends the AI/ML model via the UP, where the protocol data unit (PDU) packets includes the model ID.

If model transfer occurs via the UP, model transfer may be initiated after PDU session establishment (either at the CN or the gNB).

If model management is located at the UE-side, the UE sends a request to update the model via MAC CE, RRC, and/or NAS signaling to the gNB and/or CN, (e.g., via a model update request message) together with the model ID of the requesting updated model. The request can further include performance information generated from model management and the training dataset for model training and/or updating. The UE can also report performance information and training data collection according to the NW configuration via a model update request message or other RRC signaling.

The network further sends the update model information (including applicable conditions, uncertainty level, data collection information, among others) via MAC CE, RRC, and/or NAS signaling, e.g., the model update response message. The NW further sends the updated model either via the UP or CP.

If model management is located at the NW side, the NW (e.g., the gNB, CN) can send the model ID of the updated model to the UE over air interface signaling (e.g., RRC, NAS): 1) the network further includes the update model information (including applicable conditions, uncertainty level, data collection information, etc.) via MAC CE, RRC, and/or NAS signaling, e.g., the model update response message; 2) the NW further sends the updated model either via the UP or CP; 3) the UE may not send the model update request message.

In some embodiment, the CN further sends a message to the gNB and/or OAM to transfer the model to the UE via the CP or UP.

### Model Identification for Functionality-Based LCM

The model identification may be effectively replaced by functionality identification and identification of availability of applicable models for a given NW configuration and NW and UE additional conditions. The additional conditions include deployment characteristics/configurations for the NW or capabilities/current states (e.g., power, compute capabilities) for the UE that may not be explicitly shared with the other party (the UE and NW respectively), but they influence applicability of the available model(s) for inferencing.

In this embodiment, model identification between network and a UE is supported under functionality-based life cycle management.

The model ID is globally unique or unique within the cell and/or the gNB, CN, and/or UE under one sub-use case, i.e., different use cases may have the same model ID.

The UE sends the set of applicable conditions of the active model(s) to the NW for a specific sub-use case via a separate procedure over RRC signaling, e.g., UAI.

The UE may initiate reporting of the applicable conditions of model/models based on the configuration, upon a change of the applicable conditions of the model, or upon a network request.

Alternatively, or in addition, the applicable conditions for identification of the model(s) may be provided to the UE by the NW. The provided conditions may include network-side conditions and additional conditions to ensure appropriate selection of the model(s), e.g., to achieve suitable model performance, or to maintain consistency between training and inference, among others.

In another example, the NW may provide the UE with configuration(s) and/or indication(s) for data collection that may be associated with one or more AI/ML model(s). The model(s) may be already identified via prior assignment of the model ID(s) or be assigned with ID(s) at the time of association to the configuration(s) and/or indication(s).

Alternatively, the model(s) may be identified by associating to a provided configuration(s) and/or indication(s) for data collection that, in turn, may be referred to via one or more identifiers provided by the NW. For instance, a combination of one or more configuration(s) and/or indication(s) may be provided for data collection for model training that may include one or more aspects of: the measurement time window, set of transmission-reception points (TRPs) defining a measurement region, Tx antenna/beamforming configuration, channel characteristics, and serving/camping cell association. Further, this combination of one or more configuration(s) may be referred to with an identifier that may be associated with one or more model(s). Thus, with such association, the corresponding model(s) may be identified by reference to the identifier of the combination of one or more configuration(s) and/or indication(s). This may be referred to as an associated ID and may at least to indicate NW-side additional conditions for development (i.e., training of) and use (i.e., inferencing w/) UE-sided models.

For this option, due to the association between the model(s) and the configuration(s) and/or indication(s) for data collection, the model IDs can be logical in that the model IDs may not be unique for each model, That is, multiple physical models may be associated with a set of configuration(s) and/or indication(s) for data collection and share a common model ID.

In another example of the embodiment, in addition or as an alternative to reporting of applicable condition(s) for model(s) or configuration(s) for data collection, model identification may be realized via an indication of a dataset(s) associated with an identified functionality as part of functionality-based LCM or an identified model as part of model-based LCM. The indication of the dataset(s) may involve dataset transfer or indication of a previously identified dataset. For both cases, the dataset(s) may be provided with an identifiable dataset ID(s).

Further, the indication of a previously identified dataset(s) may be reported by a UE to the NW, e.g., for cases where the functionality/model LCM is primarily under the responsibility of the NW. In the reverse direction, the indication of a previously identified dataset(s) may be provisioned to a UE by the NW, e.g., for when the dataset(s) is trained at the network side and transferred to the UE, or, a previously identified dataset may be updated by the network.

With the indication of the dataset(s), the model identification may be realized if model-to-dataset mapping is aligned between the UE and the NW, either explicitly or implicitly.

Examples of explicit association include: an explicit configuration of association between a previously identified model(s) and dataset(s) and an explicit configuration of association between a previously identified model(s) and one or more transferred dataset(s).

Implicit association may be achieved via identification of conditions for the applicability of both of the transferred dataset(s) and model(s), or via identification of conditions for the applicability of one or more model(s) for a transferred dataset. As noted above, at least for NW-side additional conditions, this can be aligned between the NW and UE via the associated ID that can be provided to a UE for a training data collection stage and for inferencing operation.

In terms of applicable use-cases, model identification with dataset transfer can be useful at least for two-sided models for a channel state information (CSI) compression use-case. In addition, for a positioning use-case “Case 1” involving UE-based direct AI/ML positioning, instead of relying on the UE or positioning reference unit (PRU) to determine estimates of location coordinates, the LMF may provide ground-truth labels, determined based on estimates using measurement data from PRUs and/or UEs. The label and its related data (e.g., time stamp) can be generated by the PRU, a non-PRU UE with estimated location, or LMF. Such an option can reduce the reliance on PRUs for location coordinate estimates as the LMF can provide such estimates based on measurement data reported by the UE(s). Accordingly, the dataset with measurements and associated ground-truth labels (location coordinates) can be transferred/delivered from the LMF to the UE for model training at the UE.

Note that the UE referred to in the current context that receives a transferred dataset can also be the UE-side OTT server. Along with the model identification procedure, a dataset for model training is sent to the UE-side OTT server for the corresponding model.

### Management Control

To manage the AI/ML model, the gNB allocates a local ID to the UE via RRC signaling, MAC CE, and/or DCI. The local ID may be a functionality ID (e.g., representing different sub-use cases), a specific model (global unique or cell/site/area unique), a functionality ID+model ID under a particular model, or an ID for an applicable condition.

The network may further activate/deactivate among identified models, or switch among models via RRC signaling or MAC CE. The operation may fallback to legacy operation without use of an AI/ML model means that the NW (the gNB/CN/LMF) deactivates all activated models for certain use cases. Alternatively, the NW sends a single MAC CE or RRC signaling to turn off AI/ML operation for a specific use case or for all use cases.

The network can also activate multiple models/functionalities, e.g., for specific use cases with different applicable conditions, different use cases, etc. The decision of activation/deactivation can be based on applicable conditions reported by the UE, performance monitoring of a particular model/functionality, and/or based on the UE request.

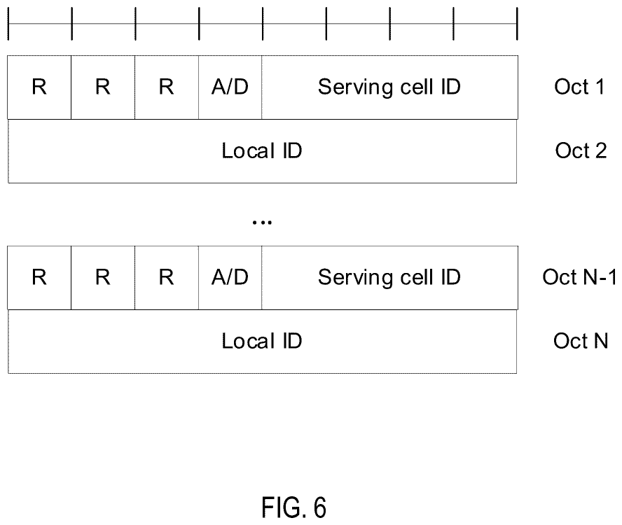

FIG. 6 illustrates an activation/deactivation MAC CE in accordance with some aspects. FIG. 6 shows an N octet MAC CE containing pairs of octets in which 4 bits of the first octet are used for the serving cell ID, one bit indicates activation/deactivation, and 3 bits are reserved, and the second octet provides the local ID.

In some embodiments, the gNB can provide a trigger event for the UE to perform management via RRC configuration. The trigger event can be: 1) a performance metrics threshold per functionality or per model ID (the threshold can further split into an entering threshold and a leaving threshold. The UE can activate/select the corresponding functionality/model when the entering threshold is met and deactivate the corresponding functionality/model when the leaving threshold is met); or 2) an applicable condition change per functionality or per model ID. This change can be a single bit indicator to configure whether the UE is allowed to switch the model based on an applicable condition change at the UE side.

Furthermore, the network can additionally provide the corresponding model ID of the model that is applicable for such conditions based on model information received by the network during model identification. The UE may or may not send applicable condition(s) at the UE-side to the NW.

A UE capability is used to indicate whether the UE supported multiple models for a (sub)use case. The capability is supported per function/(sub)use case. Alternatively, or in addition, the UE can report its memory/cache/HW processing capability.

### UE Capability

For functionality-based LCM, the UE reports its capability supporting the AI/ML air interface with following options:

Option 1: the UE reports supported (sub-)use cases, an indication of the supported use case indicates the UE supports all relevant LCM requirements to support the corresponding use case. The LCM requirements may include one or more of: model training, data collection for both the UE-side/NW-side model, and model management, among others.

Option 2: the UE reports supported (sub-)use cases with the entity of model inference. An indication of the supported feature indicates that the UE supports all corresponding LCM components for the use case.

Option 3: the UE reports supported (sub-)use cases with the model side with granularity of supported LCM components. An indication of the supported feature indicates that the UE supports the corresponding LCM component for the use case.

Option 4: the UE reports supported (sub-)use cases with granularity of supported LCM components.

Option 5: the UE reports supported (sub-)use cases with output information.

Option 5: the UE reports supported LCM components for all use cases.

Option 6: the UE reports supported data collection, e.g. data metrics.

Option 7: the UE reports supported model IDs.

### Group the UE Sharing Model

If multiple of the UEs share the same model (transferred from the NW, e.g., the gNB or CN), the model of the group of the UEs can be transmitted via group scheduling via a new Radio Network Temporary Identifier (RNTI) such as an AIML-RNTI. The model can be managed together via the new RNTI. An AI/ML model broadcast/multicast session can be established by the gNB or CN for AI/ML model transfer. The broadcast/multicast session can also terminated at the gNB if model is in the gNB. The gNB either establishes the session on its own or requests the CN to establish the session. If the model is from the OTT-server, the model can also be broadcasted as a multicast/broadcast service.

### LPP/SLPP/LMF Enhancement

One enhancement for the above model identification and dataset transfer may also be applicable to LTE Positioning Protocol (LPP) data collection for positioning accuracy enhancement use cases, including dataset with labelled data association of ground truth information from the LMF to the UE, and the above embodiments.

For a NG-RAN node that performs model inference to generate predicted measurement results to assist LMF positioning, the NG-RAN node indicates its capability of supporting AI/ML prediction and the corresponding model/functionality information (e.g., applicable conditions, output). The LMF can select/manage the AI/ML model operating at the gNB side over the NRPPa interface.

Additionally, the LMF can send the dataset used for model training (e.g., labelled data) to the UE/UE-side OTT server using the below options:

Option 1: the LMF to the UE via LPP of sideling positioning protocol (SLPP) signaling in the downlink (DL).

Option 2: the LMF to the UE-side OTT server via the CN (e.g., the NWDAF). The NWDAF can request data collection from the LMF and share the information to other NWDAFs or the UE-side OTT server.

Option 3: the LMF to the UE-side OTT server via the OAM. The OAM can request data collection from the LMF and share the information externally to the UE-side OTT server.

### Area Scope of Model

For each NW-sided or the UE-sided model, an area scope can be associated with the model, indicating the valid area of one AI/ML model.

For AI/ML positioning case 1, regarding the assistance data provided from the LMF to the UE, for ensuring consistency between training and inference: each existing assistance data information element (IE) of the UE-based DL-time difference of arrival (TDOA) and/or the UE-based DL-angle of departure (AoD) may be explicitly indicated, implicitly indicated and/or other.

TABLE 1
Existing assistance data (supported up to Rel-18)
that may be transferred from LMF to UE in UE-based
DL-TDOA or UE-based DL-AoD, as applicable

| | | |
|---|---|---|
| | UE- | UE- |
| | based | based |
| | DL- | DL- |
| Information | TdoA | AoD |

| | |
|---|---|
| 1 | Physical cell IDs (PCIs), global cell IDs (GCIs), |
| | ARFCN, and PRS IDs of candidate NR TRPs for |
| | measurement |
| 2 | Timing relative to the serving (reference) TRP of |
| | candidate NR TRPs |
| 3 | DL-PRS configuration of candidate NR TRPs |
| 4 | Indication of which DL-PRS Resource Sets across DL- |
| | PRS positioning frequency layers are linked for DL- |
| | PRS bandwidth aggregation |
| 5 | SSB information of the TRPs (the time/frequency |
| | occupancy of SSBs) |
| 6 | Spatial direction information (e.g. azimuth, elevation |
| | etc.) of the DL-PRS Resources of the TRPs served by |
| | the the gNB |
| 7 | Geographical coordinates of the TRPs served by the |
| | the gNB (include a transmission reference location |
| | for each DL-PRS Resource ID, reference location for |
| | the transmitting antenna of the reference TRP, relative |
| | locations for transmitting antennas of other TRPs) |
| 8 | Fine Timing relative to the serving (reference) TRP of |
| | candidate NR TRPs |
| 9 | PRS-only TP indication |
| 10 | The association information of DL-PRS resources with |
| | TRP Tx TEG ID |
| 11 | LOS/NLOS indicators |
| 12 | On-Demand DL-PRS-Configurations, possibly |
| | together with information on which configurations are |
| | available for DL-PRS bandwidth aggregation |
| 13 | Validity Area of the Assistance Data |
| 14 | PRU measurements together with the location |
| | information of the PRU |
| 15 | Data facilitating the integrity results determination of |
| | the calculated location |
| 16 | TRP beam/antenna information (including azimuth |
| | angle, zenith angle and relative power between PRS |
| | resources per angle per TRP) |
| 17 | Expected Angle Assistance information |
| 18 | PRS priority list |

Table 8.12.2.1.0-1 in 38.305, UE positioning in NG-RAN (Release 18), v18.3. Table 8.11.2.1.0-1 in 38.305, UE positioning in NG-RAN (Release 18), v18.3.0

For the UE-sided model, the UE can store the AI/ML model after model identification in the access stratum (AS) layer or application layer. The activated model is stored at the AS layer. When the UE is not in the RRC_CONNECTED state, the UE can release/delete the AI/ML model when the UE moves out of the area scope of the UE or the area scope of the corresponding AI/ML model.

When the UE enters the RRC_IDLE/INACTIVE state and returns to the RRC_CONNECTED state, if a model is outside of the area scope, the UE will not report the corresponding model ID to the network.

### RRC State Management

For active AI/ML model(s) operating only in the RRC_CONNECTED state, when the UE enters the RRC_INACTIVE/IDLE state, for the UE-sided model, the UE can autonomously deactivate the active model(s). When the UE returns to the RRC_CONNECTED state, the UE sends the model ID and corresponding model information (including applicable conditions) to the network, checking whether the model can be re-activated, e.g. via the RRCReestablishmentRequest or RRCResume. The network sends an accept or reject response or reconfiguration containing the model ID to the UE, indicating the reported model can be re-activated or continue being de-activated.

The NW can also include a deactivation message as in the above management control section before sending the UE to the RRC_IDLE state. Alternatively, the NW may send the deactivation indicator to deactivate all models/functions in the RRCRelease message.

The UE in the INACTIVE state can retain the model. The UE can autonomously re-use the model when the UE enters the CONNECTED state or configured to re-use the model by the network in the Resume message.

If model can be activated in the RRC_INACTIVE state, the network can configure certain pre-conditions on when the UE can release/deactive the AI/ML model before the UE enters the RRC_INACTIVE state. When the conditions of applicability for the model have changed, the UE performs the corresponding management according to the network pre-configuration.

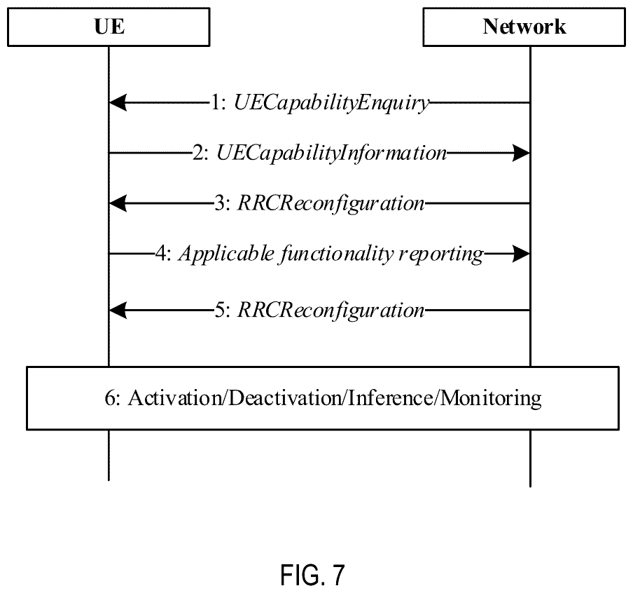

FIG. 7 illustrates functionally based LCM in accordance with some aspects. In particular, FIG. 7 shows capability and applicability signaling using UE capability and RRC messages. The supported functionalities may refer to UE-capability information/parameters i.e., Rel-19 AI/ML-enabled features or feature groups to indicate support of a (sub-)use-case or functionality.

At operation 1, the network sends a UECapabilityEnquiry message to the UE. In response, at operation 2, the UE sends a UECapabilityInformation message to the network.

At operation 3, the network sends an RRC (re)configuration message to the UE. In response, at operation 4, the UE sends an Applicablefunctionality reporting message to the network. The Applicablefunctionality reporting message may indicate the applicability for one or more CSI-ReportConfig for inference configuration or one or more sets of inference related parameters. The inference related parameters may include one/more of: associated ID, set A related information, set B related information, report content related information, and/or for BM-Case 2: time instances related information for measurements and time instances related information for prediction.

At operation 5, the network sends an RRC Reconfiguration message to the UE. The RRC Reconfiguration message may configure CSI-ReportConfig for an inference configuration including any associated ID. Aperiodic and semi-persistent CSI reports can be activated/triggered by the NW after a RRCReconfigurationComplete message is sent. A periodic CSI report is considered as activated after reception of the RRCReconfigurationComplete message.

At operation 6, one or more AI/ML models may be activated or deactivated, or may be monitored or used for inference.

The LCM for AI/ML models in the air interface are described, including model identification procedures for UE-side or UE-part of two-sided AI/ML models. The application of AI/ML techniques to the NR air interface involves mechanisms to identify, manage, and control models between the network and UE. In particular, model identification is described for UE-sided models (trained by UE), network-trained UE-sided models, and two-sided models (with components at both network and UE sides). AI/ML models may be used in various uses cases including beam management, CSI compression, and positioning.

The AI/ML model may be used to predict optimal beams in spatial or spatial-temporal dimensions. For example, the AI/ML model may be used to predict the best beam for a moving UE based on a subset of measurements rather than measuring all possible beams, reducing overhead and power consumption.

The AI/ML model may be used AI/ML to enable more efficient compression of CSI than current codebooks, providing richer information for the same overhead. This involves paired encoder/decoder models at the UE and network sides.

The AI/ML model may be used for UE-based direct AI/ML positioning in which the AI/ML model resides at the UE. The UE performs measurements and, with information from the Location Management Function (LMF), can infer location coordinates directly.

For UE-initiated model identification, the model is trained by the UE or UE-side OTT server. The UE performs model identification to synchronize the model ID with the network. This embodiment includes procedures for model registration, update, and management.

For network-initiated model identification, the model is trained by the network. In this case, the UE requests the model and corresponding ID from the network. This embodiment includes procedures for model transfer and updates.

For functionality-based LCM, model identification is provided at a higher abstraction level (functionality rather than specific model). The network provides applicable conditions to the UE for model identification, and the UE reports back whether the UE has models ready for inferencing based on these conditions. The applicable conditions may include network-side configurations (e.g., number of beams to measure, periodicity of resources) and additional conditions (proprietary deployment characteristics not explicitly indicated). The system uses associated IDs to abstract proprietary network information. The associated IDs allow the network to reference certain configurations or conditions without explicitly sharing proprietary information. The information may include antenna deployment details, exact beam widths, transmit-side beam configurations, and geographic locations of distributed antenna systems. This enables networks to maintain consistency between training and inference conditions without revealing proprietary implementation details.

Another approach uses datasets to identify models. In this case, the network provides the datasets to the UE. By identifying which dataset to use, the network implicitly identifies which model/family of models should be used. This is particularly useful for two-sided models like CSI compression. For positioning use cases, the LMF can provide ground-truth labels determined from measurements from other UEs/PRUs.

The signaling flow for functionality-based LCM starts with the network sending a UE capability inquiry. The UE responds with capability information (supported sub-use cases). The network then performs RRC configuration/reconfiguration with parameters for inference. The UE reports whether the UE has applicable models for inferencing. The network may provide further reconfiguration and can activate/deactivate/switch models or trigger monitoring.

Different aspects of model management and control include activating/deactivating models, switching between models, using a fallback to non-ML based operations, performance monitoring and reporting, and updating the model based on performance metrics. Other aspects include UE capability reporting options, area scope of models (geographical validity), RRC state management (i.e., what happens when the UE transitions between RRC states), group UE sharing models (multicast/broadcast of models).

### EXAMPLES

Example 1 is an apparatus of a user equipment (UE), the apparatus comprising a processor that configures the apparatus to: receive, from a network, a UE capability inquiry; transmit, to the network in response to the UE capability inquiry, UE capability information indicating support for an artificial intelligence/machine learning (AI/ML) sub-use case, the AI/ML sub-use case being a particular application that is narrower than another application that is a broader AI/ML use case, the support for the AI/ML sub-use case involving support of a component of AI/ML functionality life cycle management (LCM) for a UE-side AI/ML model, the functionality LCM comprising at least one of model training, data collection for the UE-side AI/ML model, or model management; receive, from the network after transmission of the UE capability information, a radio resource control (RRC) configuration comprising applicable conditions for identification of AI/ML models, the applicable conditions comprising at least one of network-side conditions or an associated identifier that abstracts additional conditions not explicitly indicated in the RRC configuration; determine whether the UE has an AI/ML model available for inferencing based on the applicable conditions; and transmit, to the network, an applicable functionality report indicating whether the UE has the AI/ML model available for inferencing.

In Example 2, the subject matter of Example 1 includes, wherein the associated identifier abstracts network deployment characteristics comprising at least one of: antenna deployment details, antenna tilts, angular configuration of antenna panels, geographic locations, beam widths, and beamforming details.

In Example 3, the subject matter of Examples 1-2 includes, wherein the applicable conditions comprise at least one of: a measurement time window, a set of transmission reception points (TRPs) defining a measurement region, a transmit antenna configuration, a beamforming configuration, channel characteristics, or a serving cell association.

In Example 4, the subject matter of Examples 1-3 includes, wherein the processor configures the apparatus to: receive, from the network, a dataset associated with the AI/ML model; and identify the AI/ML model based on the dataset.

In Example 5, the subject matter of Examples 1-4 includes, wherein at least one of: the AI/ML model is identified by associating the AI/ML model with configurations for data collection that are referred to via an identifier provided by the network, or multiple AI/ML models are associated with a set of configurations for data collection, and the AI/ML models share a common model identifier.

In Example 6, the subject matter of Examples 1-5 includes, wherein the processor configures the apparatus to: receive, from the network, an activation or deactivation message for the AI/ML model via at least one of Medium Access Control Control Element (MAC CE), RRC signaling, or downlink control information (DCI); and activate or deactivate the AI/ML model based on the activation or deactivation message.

In Example 7, the subject matter of Example 6 includes, wherein granularity of activation or deactivation is one of per functionality, per multiple AI/ML models, per function and AI/ML model, or per applicable scenario.

In Example 8, the subject matter of Examples 1-7 includes, wherein the processor configures the apparatus to: receive, from the network, information on a validity area associated with the AI/ML model; and determine whether to use the AI/ML model based on a current location of the UE relative to the validity area.

In Example 9, the subject matter of Examples 1-8 includes, wherein the processor configures the apparatus to: autonomously deactivate the AI/ML model when the UE transitions from a RRC connected state to an RRC idle state or an RRC inactive state; and transmit, to the network, model information in response to the UE transitioning back to the RRC connected state from the RRC idle state or RRC inactive state.

In Example 10, the subject matter of Examples 1-9 includes, wherein: AI/ML use cases include at least one of AI/ML-based beam prediction, AI/ML-based channel state information (CSI) feedback, or UE positioning, and the AI/ML sub-use case comprises at least one of: spatial or temporal beam prediction, channel state information (CSI) compression or CSI prediction, or UE-based positioning using the UE-side AI/ML model.

In Example 11, the subject matter of Examples 1-10 includes, wherein the processor configures the apparatus to: monitor performance of the AI/ML model based on performance indicators and monitoring resource configurations received from the network; and report the performance to the network.

In Example 12, the subject matter of Examples 1-11 includes, wherein the processor configures the apparatus to: receive, from the network, a dataset transfer configuration; and receive, from the network, a dataset to train or update the AI/ML model according to the dataset transfer configuration.

In Example 13, the subject matter of Examples 1-12 includes, wherein the processor configures the apparatus to: receive, from a Location Management Function (LMF), ground-truth labels determined based on measurement data from positioning reference units (PRUs) or other UEs; and train or update the AI/ML model using the ground-truth labels.

In Example 14, the subject matter of Examples 1-13 includes, wherein the processor configures the apparatus to: receive, from the network, a trigger event configuration for model management; and in response to a trigger event occurring, perform at least one of model selection, model switching, or model deactivation based on the trigger event configuration.

In Example 15, the subject matter of Example 14 includes, wherein the trigger event comprises at least one of: a performance metrics threshold being crossed, an applicable condition change, or a network request.

In Example 16, the subject matter of Examples 1-15 includes, wherein the UE capability information further indicates at least one of: supported model training capabilities, supported data collection capabilities, supported model management capabilities, or supported model inference capabilities.

Example 17 is an apparatus of a next generation radio access node (NG-RAN) node, the apparatus comprising a processor that configures the apparatus to: transmit, to a user equipment (UE), a UE capability inquiry; receive, from the UE in response to transmission of the UE capability inquiry, UE capability information indicating support for an artificial intelligence/machine learning (AI/ML) sub-use case, the AI/ML sub-use case being a particular application that is narrower than another application that is a broader use case, the support for the AI/ML sub-use case involving support of a component of AI/ML functionality life cycle management (LCM) for a UE-side AI/ML model, the functionality LCM comprising at least one of model training, data collection for the UE-side AI/ML model, or model management; transmit, to the UE, after reception of the UE capability information, a radio resource control (RRC) configuration comprising applicable conditions for identification of AI/ML models, the applicable conditions comprising at least one of network-side conditions or an associated identifier that abstracts additional conditions not explicitly indicated in the RRC configuration; and receive, from the UE, an applicable functionality report indicating whether the UE has an AI/ML model available for inferencing.

In Example 18, the subject matter of Example 17 includes, wherein the associated identifier abstracts network deployment characteristics comprising at least one of: antenna deployment details, antenna tilts, angular configuration of antenna panels, geographic locations, beam widths, and beamforming details.

Example 19 is a non-transitory computer-readable storage medium that stores instructions for execution by one or more processors of an apparatus of a user equipment (UE), the instructions, when executed, cause the apparatus to: receive, from a network, a UE capability inquiry; transmit, to the network in response to the UE capability inquiry, UE capability information indicating support for an artificial intelligence/machine learning (AI/ML) sub-use case, the AI/ML sub-use case being a particular application that is narrower than another application that is a broader use case, the support for the AI/ML sub-use case involving support of a component of AI/ML functionality life cycle management (LCM) for a UE-side AI/ML model, the functionality LCM comprising at least one of model training, data collection for the UE-side AI/ML model, or model management; receive, from the network after transmission of the UE capability information, a radio resource control (RRC) configuration comprising applicable conditions for identification of AI/ML models, the applicable conditions comprising at least one of network-side conditions or an associated identifier that abstracts additional conditions not explicitly indicated in the RRC configuration; determine whether the UE has an AI/ML model available for inferencing based on the applicable conditions; and transmit, to the network, an applicable functionality report indicating whether the UE has the AI/ML model available for inferencing.

In Example 20, the subject matter of Example 19 includes, wherein the associated identifier abstracts network deployment characteristics comprising at least one of: antenna deployment details, antenna tilts, angular configuration of antenna panels, geographic locations, beam widths, and beamforming details.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a user equipment (UE), the apparatus comprising a processor that configures the apparatus to:
receive, from a network, a UE capability inquiry;
transmit, to the network in response to the UE capability inquiry, UE capability information indicating support for an artificial intelligence/machine learning (AI/ML) sub-use case, the AI/ML sub-use case being a particular application that is narrower than another application that is a broader AI/ML use case, the support for the AI/ML sub-use case involving support of a component of AI/ML functionality life cycle management (LCM) for a UE-side AI/ML model, the functionality LCM comprising at least one of model training, data collection for the UE-side AI/ML model, or model management;
receive, from the network after transmission of the UE capability information, a radio resource control (RRC) configuration comprising applicable conditions for identification of AI/ML models, the applicable conditions comprising at least one of network-side conditions or an associated identifier that abstracts additional conditions not explicitly indicated in the RRC configuration;
determine whether the UE has an AI/ML model available for inferencing based on the applicable conditions; and
transmit, to the network, an applicable functionality report indicating whether the UE has the AI/ML model available for inferencing.

2. The apparatus of claim 1, wherein the associated identifier abstracts network deployment characteristics comprising at least one of: antenna deployment details, antenna tilts, angular configuration of antenna panels, geographic locations, beam widths, and beamforming details.

3. The apparatus of claim 1, wherein the applicable conditions comprise at least one of: a measurement time window, a set of transmission reception points (TRPs) defining a measurement region, a transmit antenna configuration, a beamforming configuration, channel characteristics, or a serving cell association.

4. The apparatus of claim 1, wherein the processor configures the apparatus to:
receive, from the network, a dataset associated with the AI/ML model; and
identify the AI/ML model based on the dataset.

5. The apparatus of claim 1, wherein at least one of:
the AI/ML model is identified by associating the AI/ML model with configurations for data collection that are referred to via an identifier provided by the network, or
multiple AI/ML models are associated with a set of configurations for data collection, and the AI/ML models share a common model identifier.

6. The apparatus of claim 1, wherein the processor configures the apparatus to:
receive, from the network, an activation or deactivation message for the AI/ML model via at least one of Medium Access Control Control Element (MAC CE), RRC signaling, or downlink control information (DCI); and
activate or deactivate the AI/ML model based on the activation or deactivation message.

7. The apparatus of claim 6, wherein granularity of activation or deactivation is one of per functionality, per multiple AI/ML models, per function and AI/ML model, or per applicable scenario.

8. The apparatus of claim 1, wherein the processor configures the apparatus to:
receive, from the network, information on a validity area associated with the AI/ML model; and
determine whether to use the AI/ML model based on a current location of the UE relative to the validity area.

9. The apparatus of claim 1, wherein the processor configures the apparatus to:
autonomously deactivate the AI/ML model when the UE transitions from a RRC connected state to an RRC idle state or an RRC inactive state; and
transmit, to the network, model information in response to the UE transitioning back to the RRC connected state from the RRC idle state or RRC inactive state.

10. The apparatus of claim 1, wherein:
AI/ML use cases include at least one of AI/ML-based beam prediction, AI/ML-based channel state information (CSI) feedback, or UE positioning, and
the AI/ML sub-use case comprises at least one of: spatial or temporal beam prediction, channel state information (CSI) compression or CSI prediction, or UE-based positioning using the UE-side AI/ML model.

11. The apparatus of claim 1, wherein the processor configures the apparatus to:
monitor performance of the AI/ML model based on performance indicators and monitoring resource configurations received from the network; and
report the performance to the network.

12. The apparatus of claim 1, wherein the processor configures the apparatus to:
receive, from the network, a dataset transfer configuration; and
receive, from the network, a dataset to train or update the AI/ML model according to the dataset transfer configuration.

13. The apparatus of claim 1, wherein the processor configures the apparatus to:
receive, from a Location Management Function (LMF), ground-truth labels determined based on measurement data from positioning reference units (PRUs) or other UEs; and
train or update the AI/ML model using the ground-truth labels.

14. The apparatus of claim 1, wherein the processor configures the apparatus to:
receive, from the network, a trigger event configuration for model management; and
in response to a trigger event occurring, perform at least one of model selection, model switching, or model deactivation based on the trigger event configuration.

15. The apparatus of claim 14, wherein the trigger event comprises at least one of: a performance metrics threshold being crossed, an applicable condition change, or a network request.

16. The apparatus of claim 1, wherein the UE capability information further indicates at least one of: supported model training capabilities, supported data collection capabilities, supported model management capabilities, or supported model inference capabilities.

17. An apparatus of a next generation radio access node (NG-RAN) node, the apparatus comprising a processor that configures the apparatus to:
transmit, to a user equipment (UE), a UE capability inquiry;
receive, from the UE in response to transmission of the UE capability inquiry, UE capability information indicating support for an artificial intelligence/machine learning (AI/ML) sub-use case, the AI/ML sub-use case being a particular application that is narrower than another application that is a broader use case, the support for the AI/ML sub-use case involving support of a component of AI/ML functionality life cycle management (LCM) for a UE-side AI/ML model, the functionality LCM comprising at least one of model training, data collection for the UE-side AI/ML model, or model management;
transmit, to the UE, after reception of the UE capability information, a radio resource control (RRC) configuration comprising applicable conditions for identification of AI/ML models, the applicable conditions comprising at least one of network-side conditions or an associated identifier that abstracts additional conditions not explicitly indicated in the RRC configuration; and
receive, from the UE, an applicable functionality report indicating whether the UE has an AI/ML model available for inferencing.

18. The apparatus of claim 17, wherein the associated identifier abstracts network deployment characteristics comprising at least one of: antenna deployment details, antenna tilts, angular configuration of antenna panels, geographic locations, beam widths, and beamforming details.

19. A non-transitory computer-readable storage medium that stores instructions for execution by one or more processors of an apparatus of a user equipment (UE), the instructions, when executed, cause the apparatus to:
receive, from a network, a UE capability inquiry;
transmit, to the network in response to the UE capability inquiry, UE capability information indicating support for an artificial intelligence/machine learning (AI/ML) sub-use case, the AI/ML sub-use case being a particular application that is narrower than another application that is a broader use case, the support for the AI/ML sub-use case involving support of a component of AI/ML functionality life cycle management (LCM) for a UE-side AI/ML model, the functionality LCM comprising at least one of model training, data collection for the UE-side AI/ML model, or model management;
receive, from the network after transmission of the UE capability information, a radio resource control (RRC) configuration comprising applicable conditions for identification of AI/ML models, the applicable conditions comprising at least one of network-side conditions or an associated identifier that abstracts additional conditions not explicitly indicated in the RRC configuration;
determine whether the UE has an AI/ML model available for inferencing based on the applicable conditions; and
transmit, to the network, an applicable functionality report indicating whether the UE has the AI/ML model available for inferencing.

20. The non-transitory computer-readable storage medium of claim 19, wherein the associated identifier abstracts network deployment characteristics comprising at least one of: antenna deployment details, antenna tilts, angular configuration of antenna panels, geographic locations, beam widths, and beamforming details.
